(19) United States
(12) Patent Application Publication
(10) Pub. No.: US 2008/0258671 A1
(43) Pub. Date: Oct. 23, 2008

(54) CONTROL DEVICE HAVING EXCESSIVE-ERROR DETECTION FUNCTION

(75) Inventors: Yasusuke IWASHITA, Minamitsuru-gun (JP); Tadashi OKITA, Minamitsuru-gun (JP); Hiroyuki KAWAMURA, Minamitsuru-gun (JP); Junichi TEZUKA, Minamitsuru-gun (JP)

Correspondence Address: LOWE HAUPTMAN HAM & BERNER, LLP, 1700 DIAGONAL ROAD, SUITE 300, ALEXANDRIA, VA, 22314, US

(73) Assignee: FANUC LTD, Minamitsuru-gun (JP)

(21) Appl. No.: 12/098,959

(22) Filed: Apr. 7, 2008

(30) Foreign Application Priority Data
Apr. 20, 2007 (JP) 2007-112227

(51) Int. Cl. G05D 3/12

(52) U.S. Cl. 318/632

(57) ABSTRACT

Abnormality of a position error is quickly detected in a control device in which feedforward control is introduced. A position error estimation processing unit calculates a position error estimation value Err, for example, from the equation V/PG×(1−α) (V: first order differential of position command, PG: position gain in position controller, α: feedforward coefficient in feedforward term calculating unit), and abnormality of the position error is detected using an excessive-error detection level calculating by adding a margin ΔE to the position error estimation value.

### BACKGROUND OF THE INVENTION

1. Field of the Invention

The present invention relates to a control device having an excessive-error detection function for detecting an abnormality of a position error.

2. Description of the Related Art

For example, in a numerical control (NC) device that controls the rotation of a servo motor, an angular error (or more generally, position error) between a rotation angle command (or more generally, position command) to the motor and the actual rotation angle (or more generally, position feedback) is compared with a predetermined excessive-error detection level to detect an abnormality resulting from a faulty servo system, an excessive load, interference with a peripheral device, etc. In the prior art, it has been common practice to determine the excessive-error detection level by adding a certain amount of margin to an ideal position error (steady-state error) calculated from the velocity command and the position control loop gain (position gain).

However, when feedforward control is introduced to the position control, the position error under normal operation becomes less than the ideal position error calculated from the velocity command and the position gain. If the excessive-error detection level determined based on this ideal position error is used as a threshold value for abnormality detection, a problem arises in which a delay occurs in the detection of an abnormality, because in the early stage of the abnormality, the error does not reach the detection level.

### SUMMARY OF THE INVENTION

Accordingly, an object of the present invention is to provide a control device that uses an excessive-error detection level capable of detecting abnormality of a position error appropriately in a configuration where feedforward control is introduced to the position control.

According to the present invention, there is provided a control device comprising: a position controller calculating a first velocity command by multiplying by a position gain a position error detected between a position command and a position feedback from a control target; a feedforward term calculating unit calculating a feedforward term by multiplying a time differential of the position command by a feedforward coefficient; a velocity controller controlling the velocity of the control target based on a second velocity command obtained by adding the feedforward term to the first velocity command; a position error estimation value calculating unit calculating a position error estimation value from the position command, the position gain, and the feedforward coefficient; and a position error abnormality judging unit judging the position error to be abnormal when the position error is greater than the position error estimation value by more than a predetermined value.

The position error estimation value calculating unit takes as the position error estimation value a position error calculated, for example, when the velocity controller and the control target are replaced by an integrator.

In the above control device, since the position error calculated when the velocity controller and the control target are replaced by an integrator, i.e., when there is no delay in the velocity control, is taken as the position error estimation value, and the excessive-error detection level is set based on the thus calculated value, the excessive-error detection level can be set appropriately in the control device in which feedforward control is introduced.

### BRIEF DESCRIPTION OF THE DRAWINGS

FIG. 1 is a block diagram showing one configuration example of a control device in which feedforward control is not introduced;

FIG. 2 is a block diagram showing one configuration example of a velocity controller 18 in FIG. 1;

FIG. 3 is a block diagram showing one configuration example of a control device in which feedforward control is introduced;

FIG. 4 is a block diagram showing a configuration in which the velocity controller 18 and servo motor 12 in FIG. 3 are replaced by an integrator in order to calculate a position error estimation value;

FIG. 5 is a block diagram showing the configuration of a control device according to a first embodiment of the present invention;

FIG. 6 is a graph for explaining the abnormality detection operation of the control device of FIG. 5;

FIG. 7 is a block diagram showing the configuration of a control device according to a second embodiment of the present invention;

FIG. 8 is a graph explaining the abnormality detection operation of the control device of FIG. 7;

FIG. 9 is a control flowchart when the control described with reference to FIG. 5 is implemented in software; and

FIG. 10 is a control flowchart when the control described with reference to FIG. 7 is implemented in software.

### DESCRIPTION OF THE PREFERRED EMBODIMENTS

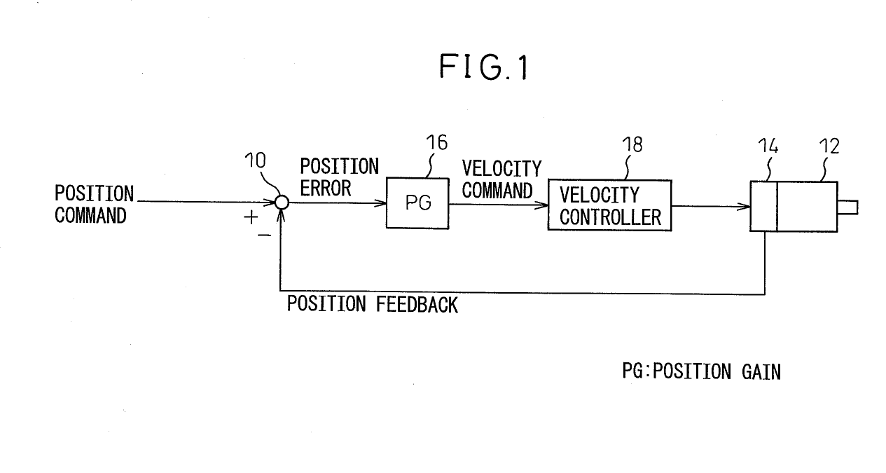

The present invention will be described by taking as an example a control device that controls the rotation of a servo motor. FIG. 1 shows the configuration of a control device in which feedforward control is not introduced. The position error between the position command and the position feedback from the servo motor 12 (the rotation angle detected by an encoder 14) is calculated by a subtractor 10. The position error is multiplied by a position gain PG in a position controller 16, and the result is supplied as a velocity command to a velocity controller 18 which controls the rotational velocity of the servo motor.

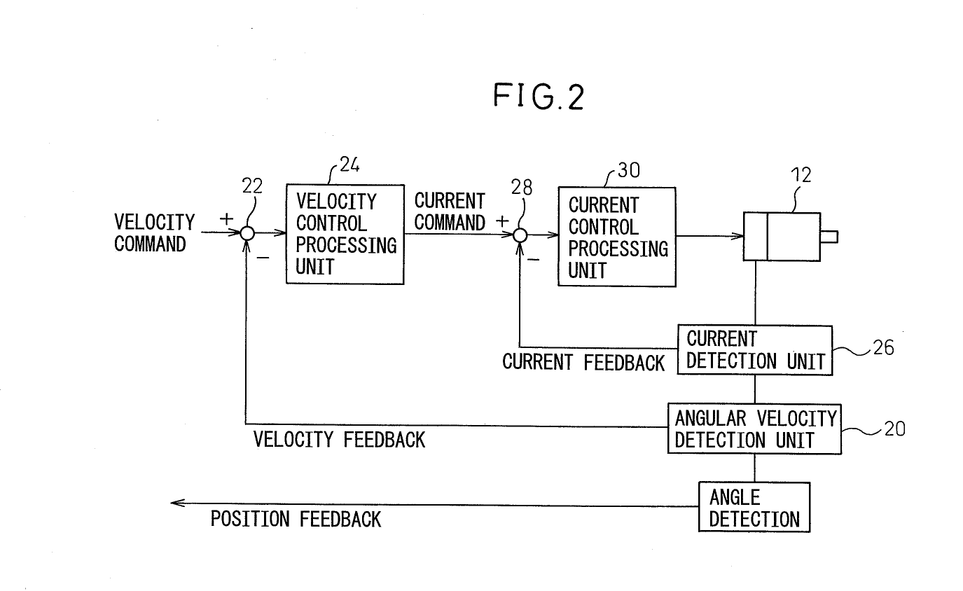

As shown, for example, in FIG. 2, the velocity controller 18 has a configuration in which a subtractor 22 calculates the velocity error between the velocity command and the angular velocity detected by an angular velocity detection unit 20, a velocity control processing unit 24 calculates a current command from the velocity error, a subtractor 28 detects the current error between the current command and the current detected by a current detection unit 26 and, based on the current error, a current control processing unit 30 controls the current that flows to the servo motor 12.

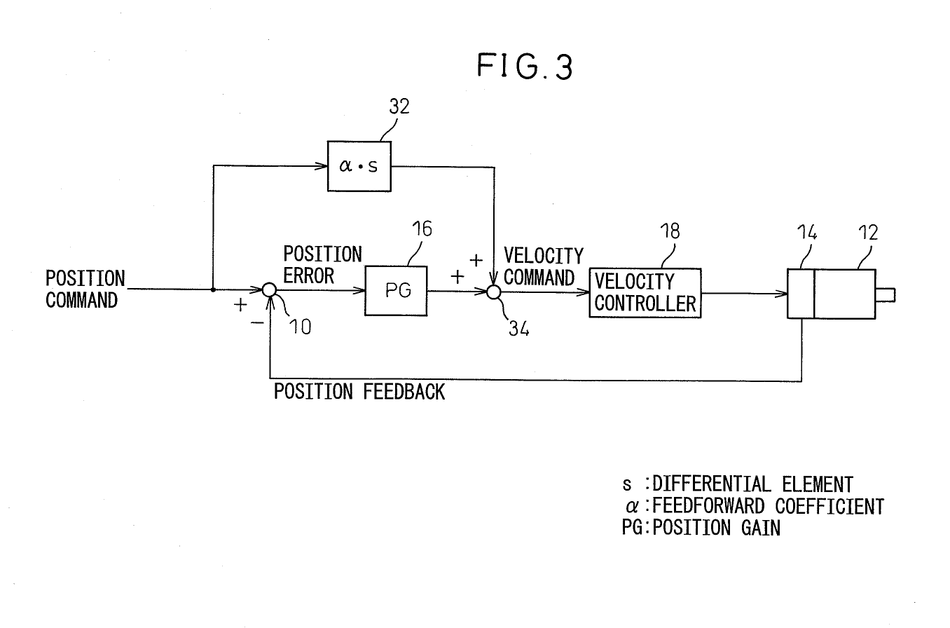

FIG. 3 shows an example where feedforward control is introduced in the control device of FIG. 1. A feedforward term calculating unit 32 calculates the time differential of the position command and multiplies it by a feedforward coefficient α to obtain a feedforward term. An adder 34 adds the feedforward term to the velocity command supplied from the position controller 16, and supplies the result as a velocity command to the velocity controller 18.

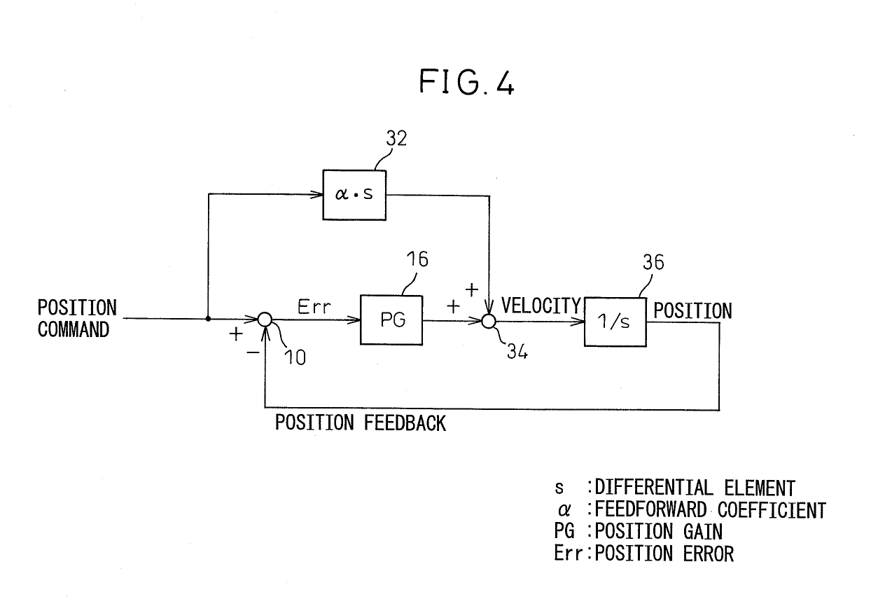

In the present invention, an error is calculated when the velocity controller 18 and servo motor 12 in FIG. 3 are replaced by an ideal integrator 36 as shown in FIG. 4, i.e., when there is no delay in the velocity controller 18 and servo motor 12, and this error is taken as a position error estimation value. Then, using the excessive-error detection level determined based on the thus calculated value, abnormality of the position error is detected. The calculation of the position error estimation value will be described below.

The position command is denoted by u(t), and the position error by Err(t), and their Laplace transforms are denoted by u(s) and Err(s), respectively. Letting F(s) denote the transfer function from the position command to the position error, the following equation is obtained.

Err(s)=F(s)·u(s)

In other words, when the transfer function F(s) is given, the position error Err(t) can be obtained from the Laplace transform u(s) of the position command u(t).

In the system shown in FIG. 4, since the transfer function F(s) from the position command to the position error is given as

F(s)=(1−α)·s/(s+PG)

the position error in the system of FIG. 4, i.e., the position error estimation value in the system of FIG. 3, can be calculated using the transfer function and the Laplace transform u(s) of the position command u(t). However, in reality, the Laplace transform of u(t) which is given in time series is difficult to obtain in advance, and therefore, an approximate function is used.

When the time differential of the position command is constant at V, that is, when the commanded rotational velocity is a constant velocity V, since the Laplace transform u(s) of the position command is V/s², the position error estimation value Err, at the limit of s→0, is given as

Err(V, PG, α)=V/PG×(1−α)

When the change of the position command is mild, this equation suffices for most purposes and can be used to calculate the value for detecting position control abnormality, though it contains a certain degree of error.

On the other hand, when the acceleration of the command or the change of the acceleration is large, an error tends to occur, and a correction can be made as shown by the following equation.

Err(V, PG, α)=V/PG×(1−α)+(second order differential of position command)×Ka+(third order differential of position command)×Kj

In the case of sample value control by digital processing, the position error estimation value can be calculated using a recurrence equation.

The transfer function from the position command u(s) to the position error Err(s) is given as

Err(s)/u(s)=(1−α)·s/(s+PG)

which is transformed into

(s+PG)·Err(s)=(1−α)·s·u(s)

By converting this into a discrete time system, i.e., Err(s)·s→(Err(n)−Err(n−1)/T, us(s)·s→(u(n)−u(n−1))/T, Err(s)→Err(n)), the following equation is obtained.

Err(n)={Err(n−1)+(1−α)(u(n)−u(n−1))}/(1+PG·T)

The position error estimation value can be obtained by calculating this recurrence equation.

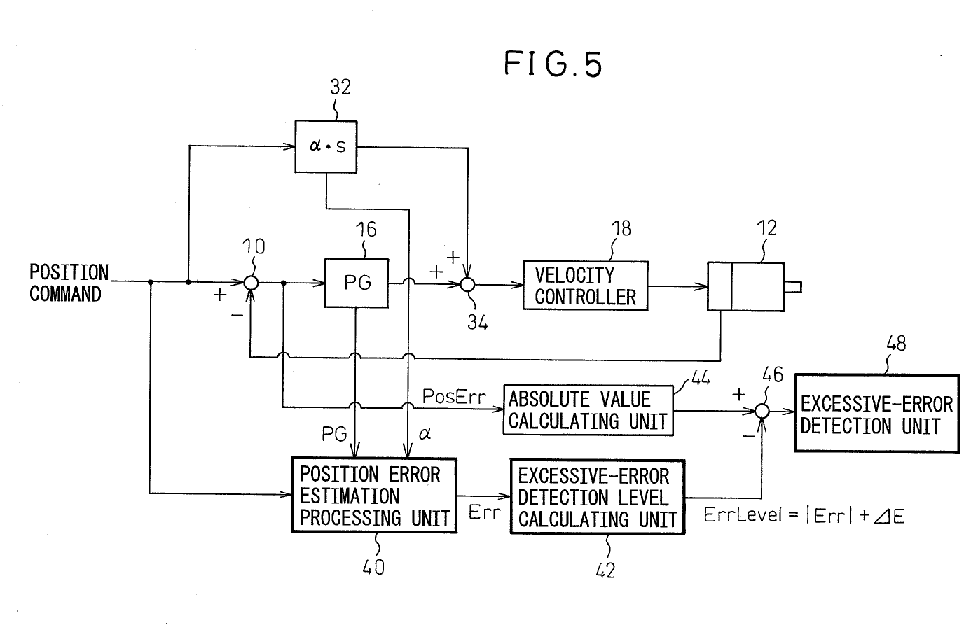

FIG. 5 shows the configuration of a control device according to one embodiment of the present invention. The same component elements as those in FIG. 3 are designated by the same reference numerals, and the description thereof will not be repeated.

Using one of the above-described techniques, a position error estimation processing unit 40 calculates the position error estimation value Err from the position command, the feedforward coefficient α used in the feedforward term calculating unit 32, and the position gain PG used in the position controller 16. Since the position error estimation processing unit 40 is repeatedly executing the calculation of the position error estimation value Err, when the set value of the feedforward coefficient α changes, the position error estimation value changes accordingly. An excessive-error detection level calculating unit 42 calculates the excessive-error detection level ErrLevel by adding a prescribed margin ΔE to the absolute value |Err| of the position error estimation value Err. On the other hand, an absolute value calculating unit 44 calculates the absolute value |PosErr| of the position error PosErr output from the subtractor 10, and a subtractor 46 subtracts the excessive-error detection level ErrLevel from it. If the result of the subtraction is negative, an excessive-error detection unit 48 determines that abnormality is detected. The margin ΔE can be set by considering the actually measured values of overshoot, etc., that occur due to the response delays of the velocity controller 18 and servo motor 12. As the commanded acceleration increases, the position error tends to increase; to address this, the amount of position error during linear acceleration/deceleration may be investigated in advance, and the abnormality detection margin may be set by considering it.

Further, in regions where the commanded acceleration changes, the position error tends to increase because of an inability to respond quickly to the change. In this case also, the relationship between the rate of change of the commanded acceleration and the amount of position error may be investigated, and the abnormality detection margin may be set by considering it.

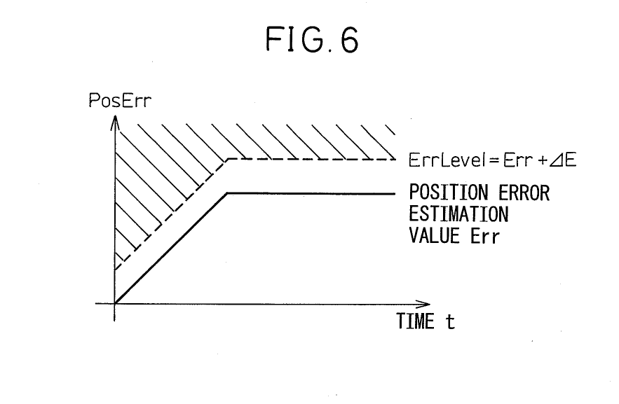

In the embodiment shown in FIG. 5, if the position error |PosErr| is greater than the position error estimation value Err by more than ΔE, i.e., if it lies in the hatched region shown in FIG. 6, the error is judged to be abnormal.

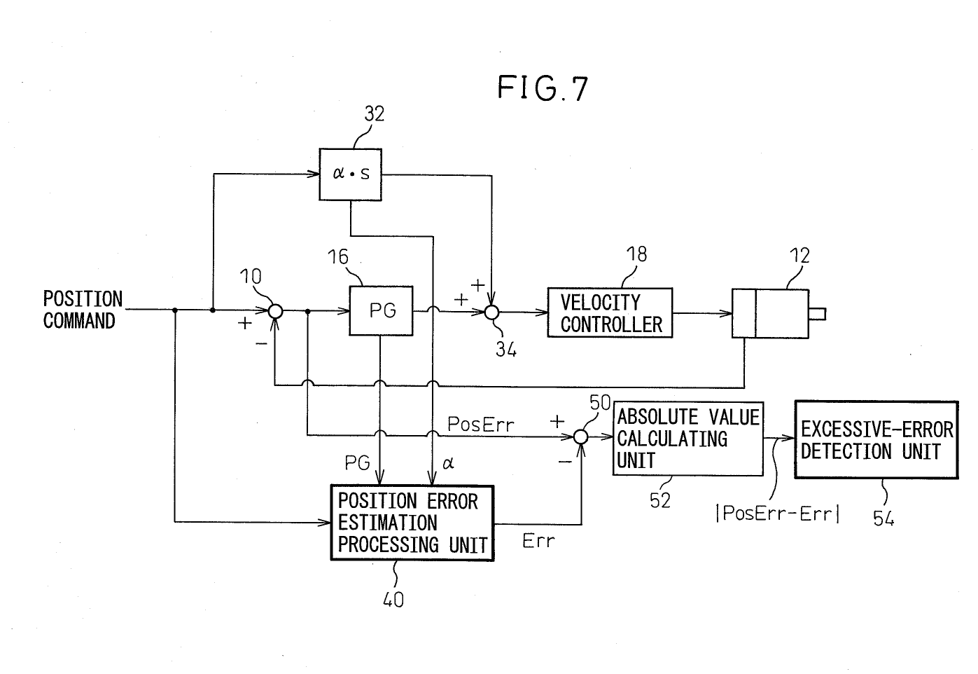

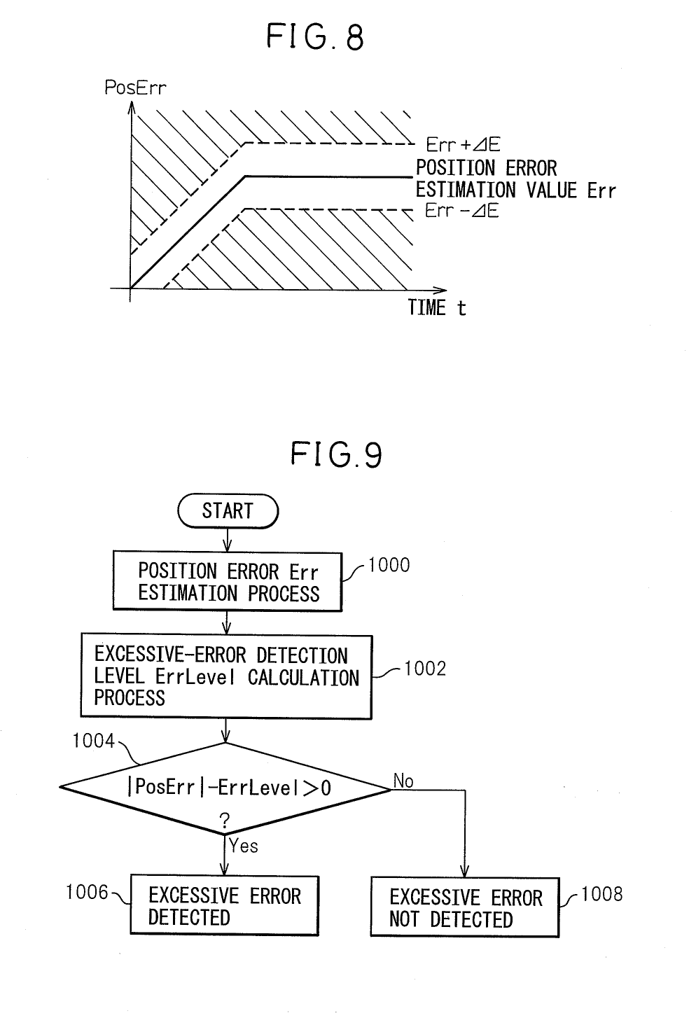

FIG. 7 shows the configuration of a control device according to a second embodiment of the present invention. In this embodiment, a subtractor 50 subtracts the position error estimation value Err from the position error PosErr, and an absolute value calculating unit 52 calculates the absolute value of the difference. An excessive-error detection unit 54 compares the absolute value with the margin ΔE, and if it is larger than ΔE, the error is judged to be abnormal.

In the embodiment shown in FIG. 7, not only when the position error PosErr is greater than the position error estimation value Err by more than ΔE, but also when it is smaller by more than ΔE, the error is judged to be abnormal. It is considered that there is some abnormality not only when the position error PosErr is greater than the normal state by more than ΔE, but also when it is smaller by more than ΔE.

FIG. 9 is a flowchart of a process when the control described with reference to FIG. 5 is implemented in software. In FIG. 9, the position error estimation value Err is calculated (step 1000), after which the excessive-error detection level ErrLevel is calculated (step 1002). If the absolute value |PosLevel| of the position error is larger than the ErrLevel (step 1004), the error is detected as an excessive error (step 1006); otherwise, the error is judged to be normal (step 1008).

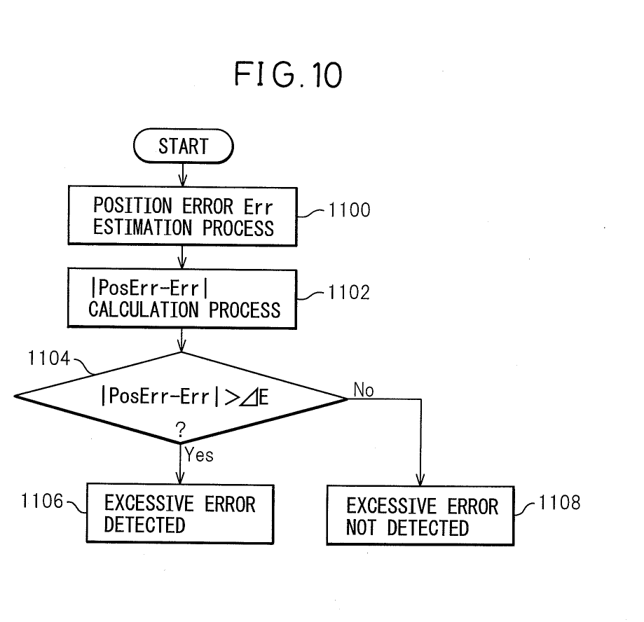

FIG. 10 is a flowchart of a process when the control described with reference to FIG. 7 is implemented in software. In FIG. 10, the position error estimation value Err is calculated (step 1100), and the absolute difference |PosErr−Err| between it and the position error is calculated (step 1102). In step 1104, the absolute difference is compared with the margin ΔE, and if it is larger than ΔE, the error is detected as an excessive error (step 1106); otherwise, the error is judged to be normal (step 1108).

1. A control device comprising:
a position controller calculating a first velocity command by multiplying by a position gain a position error detected between a position command and a position feedback from a control target;
a feedforward term calculating unit calculating a feedforward term by multiplying a time differential of said position command by a feedforward coefficient;
a velocity controller controlling the velocity of said control target based on a second velocity command obtained by adding said feedforward term to said first velocity command;
a position error estimation value calculating unit calculating a position error estimation value from said position command, said position gain, and said feedforward coefficient; and
a position error abnormality judging unit judging said position error to be abnormal when said position error is greater than said position error estimation value by more than a predetermined value.

2. A control device according to claim 1, wherein said position error estimation value calculating unit takes as said position error estimation value a position error calculated when said velocity controller and said control target are replaced by an integrator.

3. A control device according to claim 1, wherein said position error abnormality judging unit also judges said position error to be abnormal when said position error is smaller than said position error estimation value by more than a predetermined value.

4. A control device according to claim 1, wherein said position error estimation value calculating unit calculates said position error estimation value Err (V, PG, α) from an equation
Err(V, PG, α)=V/PG×(1−α)
where α denotes said feedforward coefficient, PG denotes said position gain, and V denotes the first order differential of said position command.

5. A control device according to claim 1, wherein said position error estimation value calculating unit calculates the current position error estimation value Err(n) from a recurrence equation
Err(n)={Err(n−1)+(1−α) (u(n)−u(n−1))}/(1+PG·T)
where α denotes said feedforward coefficient, PG denotes said position gain, u(n−1) denotes the previous position command, u(n) denotes the current position command, and Err(n−1) denotes the previous position error estimation value.

6. A control device according to claim 1, wherein said control target is a servo motor, said position is the rotation angle of said servo motor, and said velocity is the rotational velocity of said servo motor.
